(19) United States
(12) Patent Application Publication
(10) Pub. No.: US 2014/0136617 A1
(43) Pub. Date: May 15, 2014

(54) METHOD AND SYSTEM OF ONE-WAY ANONYMOUS COMMUNICATION

(71) Applicants: Uri Singer, Encino, CA (US); Daniel Singer, Encino, CA (US)

(72) Inventors: Uri Singer, Encino, CA (US); Daniel Singer, Encino, CA (US)

(21) Appl. No.: 13/862,693

(22) Filed: Apr. 15, 2013

Related U.S. Application Data
(63) Continuation-in-part of application No. 13/675,966, filed on Nov. 13, 2012, now Pat. No. 8,612,360.
Application No. 13/675,966 is a continuation-in-part of application No. 12/070,340, filed on Feb. 15, 2008, now Pat. No. 8,311,949.
(60) Provisional application No. 61/757,956, filed on Jan. 29, 2013.
(60) Provisional application No. 60/901,476, filed on Feb. 15, 2007.
(60) Provisional application No. 60/906,005, filed on Mar. 8, 2007.
(60) Provisional application No. 60/933,965, filed on Jun. 8, 2007.

(51) Int. Cl. H04L 12/58

(52) U.S. Cl. CPC H04L 51/32
USPC 709/204

(57) ABSTRACT

In an embodiment, a method of a one-way anonymous communication system is provided. The method includes receiving a request from a first user via a first user interface to communicate one-way anonymously with a second user, and using a processor, relaying a one-way anonymous message from the first user to be received by the second user via a second user interface, wherein the one-way anonymous message discloses a second user identification to the first user while withholding a first user identification from the second user. In the embodiment, the first user and the second user are each members of the same online social network, and the first user and the second user have a contact request connection, and the contact request connection was formed by acceptance of a contact request between the first user's contact group and the second user's contact group.

### CROSS REFERENCE TO RELATED APPLICATIONS

This application claims priority from U.S. Provisional Patent Application Ser. No. 61/757,956 filed on Jan. 29, 2013, and is a continuation-in-part of and claims priority from U.S. Utility patent application Ser. No. 13/675,966, filed on Nov. 13, 2012, which claims priority from U.S. patent application Ser. No. 12/070,340 filed Feb. 15, 2008, which claims priority from U.S. Provisional Patent Application Ser. No. 60/901,476, filed Feb. 15, 2007, Ser. No. 60/906,005, filed Mar. 8, 2007, and Ser. No. 60/933,965, filed Jun. 8, 2007, all of which are incorporated by reference herein.

### BACKGROUND

1. Field of Technology

The invention relates to communication, and more particularly to a method and system of one-way anonymous communication.

2. Related Art

In conventional communication systems, users of an online social network may be provided with limited options for communication, which may restrict how the members are able to communicate with each other. For example, communication may be restricted to traditional communication formats such as email, in which each message includes such information as sender, receiver, time sent, subject line, and the body of a message. Such traditional formats may, by being a familiar form of communication, prevent communication that might otherwise occur.

### SUMMARY

In an aspect, a method of a one-way anonymous communication is provided. The method includes receiving a request from a first user via a first user interface to communicate one-way anonymously with a second user (so that the second user is known to the first user but the first user, although linked to and previously known to the second user, is not known to the second user for such anonymous communication with the first user). The first user and the second user are each members of the same online social network, and the first user and the second user have a contact request connection which is preferably pre-existing (e.g., they are “linked”). The contact request connection was formed by acceptance of a contact request between the first user's contact group and the second user's contact group. The first user's contact group includes the first user and the first user's contacts, and the second user's contact group includes the second user and the second user's contacts. The method also includes, using a processor, relaying a one-way anonymous message from the first user to be received by the second user via a second user interface, wherein the one-way anonymous message discloses a second user identification to the first user while withholding a first user identification from the second user.

In another aspect, a tangible computer readable storage medium that includes instructions is provided. The instructions, when executed by a processor, cause the processor to perform operations, including receiving a request from a first user via a first user interface to communicate one-way anonymously with a second user, and using a processor, relaying a one-way anonymous message from the first user to be received by the second user via a second user interface, wherein the one-way anonymous message discloses a second user identification to the first user while withholding a first user identification from the second user. The first user and the second user are each members of the same online social network, and the first user and the second user have a preferably pre-existing contact request connection. The contact request connection was formed by acceptance of a contact request between the first user's contact group and the second user's contact group. The first user's contact group includes the first user and the first user's contacts, and the second user's contact group includes the second user and the second user's contacts.

In another aspect, a one-way anonymous communication system is provided. The system includes a first user interface configured to receive a request from a first user to communicate one-way anonymously with a second user, and a processor configured to relay a one-way anonymous message from the first user to be received by the second user via a second user interface, wherein the one-way anonymous message discloses a second user identification to the first user while withholding a first user identification from the second user. The first user and the second user are each members of the same online social network, and the first user and the second user have a preferably pre-existing contact request connection, the contact request connection was formed by acceptance of a contact request between the first user's contact group and the second user's contact group, and the first user's contact group includes the first user and the first user's contacts, and the second user's contact group includes the second user and the second user's contacts.

### BRIEF DESCRIPTION OF THE DRAWINGS

FIG. 1 is an illustration of a system and method for one-way anonymous communication, according to an embodiment;

FIG. 2 is an illustration of an additional system and method for one-way anonymous communication, according to an embodiment;

FIG. 3 is an illustration of a system and method for two-way anonymous communication, according to an embodiment;

FIG. 4-7 are illustrations of user interfaces for one-way and/or two-way anonymous communication, according to various embodiments;

FIG. 8 is a schematic diagram of a system for one-way anonymous communication, according to an embodiment;

FIG. 9 is an illustration of new users becoming members of a one-way communication system, according to an embodiment;

FIG. 10 is a block diagram showing a user A's contact group, a user B's contact group, a contact request connection, and a contact request connection, according to an embodiment;

FIG. 11 is a block diagram showing clue information, online social network data, and information from users, according to an embodiment;

FIG. 12 is a flow chart of exemplary steps of a method of performing one-way anonymous communication, according to an embodiment;

FIG. 13 is a flow chart of exemplary steps of a method of performing one-way anonymous communication, according to another embodiment;

FIG. 14 is a block diagram of device components for performing the operations of the method of one-way and/or two-way anonymous communication, according to an embodiment; and

FIG. 15 is a flow chart of exemplary operations of a one-way anonymous communication system in accordance with an embodiment.

### DESCRIPTION OF THE PREFERRED EMBODIMENT(S)

In an embodiment, a one-way anonymous communication (“OWAC”) system may be used in conjunction with and/or be a part of an online social network (e.g., Facebook®, Google+®, Twitter®, Skype®, LinkedIn®, FourSquare®, etc.) to allow users to initiate a one-way anonymous, private, or public conversation. In another embodiment, the system may permit two-way anonymous, private or public conversations. Conversations may include emails, text messages, SMS messages, photos, videos, etc. The system may provide a different and fun way to talk to people, discuss opinions, and/or give feedback.

### DEFINITIONS

As used herein, the below terms are defined as set forth below: “Online social network” means a web-based or electronic communications network based service or system that allow “users” (individuals or entities) to (i) construct a private, public or semi-public profile within a bounded system, the profile having information about the user stored as “social network data,” which information is typically personal information; (ii) articulate a list (“contact group”) of other users with whom they share a “connection,” and (iii) view and traverse their list of connections and those made by others within the system. Examples of existing “online social networks” include Facebook®, Google+®, Twitter®, Skype®, LinkedIn®, FourSquare®, etc.

“Contact request connection” means a “connection” in an “online social network” of one user to another user, where the connection was formed by any of the following: (i) acceptance of a request between a first user and a second user to have the second user be in the first user's list of contacts (“contact group”); (ii) acceptance of a request between any user in the first user's contact group and any user in the second user's contact group. The first user's contact group includes the first user and the first user's contacts, and the second user's contact group includes the second user and the second user's contacts. In Facebook® for example, the first and second users would have a “contact request connection” if the first user accepted the second user's “friend request” or if the second user accepted the first user's “friend request.” The same would be true in LinkedIn® if a first user accepted a second user's request to “connect” or if a second user accepted a first user's request to “connect.” Therefore, a “contact request connection” would be satisfied in a preferred embodiment where user A and user B are associated simply by being friends-of-friends in “Facebook®,” or “connections” to “connections” in LinkedIn®.

“Contact group” means, in accordance with the “online social network's” protocol, a list of contacts or friends or other users connected, linked or associated with a primary user, where the primary user has accepted all of the users in the “contact group” by (i) the other users requesting to be connected to the primary user and the primary user accepting the request; and/or (ii) the primary user requesting to be connected to the other user(s) and the other user(s) accepting the request.

“User profile” means the profile that a user of an online social network has which is stored on the network in association with the user, and typically includes a user I.D., a password, a username (which may or may not be the same as the user I.D.), and other information, such as real name, geographic location data, schools attended data, job data, likes and/or dislikes data, photos, and other data as is known by those of ordinary skill in the art.

“User's associated data” may include “user profile” data as well as data posted on a user's wall (such as in Facebook®) or data posted by the user, or other data posted about the user, linked to the user by username or I.D.

“Identifying data” as used herein is data that enables identification of one user to another user on an online social network, such as username and/or user I.D. and/or real name. “Anonymous” as used herein means lacking “identifying data” for a particular user and preferably lacking any other data known to another user of the social network that may enable another user to identify the particular user. In some embodiments herein, “anonymous” may be combined with “clues,” where the clues may include profile data or online social network data associated with the particular user, but not “identifying data” associated with the particular user.

### Types of Anonymous Communication

The conversation may begin with an initiating user, who sends an initial communication request, and a target user, who receives the initial communication request. The communication request may be private (e.g., sent only to the target user), public (e.g., visible to anyone), or semi-public (e.g., subject to viewer restrictions). An example of a semi-public communication request may be a post on a target user's Facebook® wall. The posts on the wall are semi-public because more than one person can see the post, but the owner's privacy permissions may restrict non-friends and the general public from viewing the post.

In some embodiments, the initiating user may be the anonymous user, while the target user is the non-anonymous user. For example, the initiating user may start a conversation with a person from whom they've received anonymous feedback, and the initiating user may only know one or more clues about the target user, such as the relationship between the initiating user and the target user. At the same time, the target user may be aware of the initiating user's identity, and the OWAC system may provide the target user with the initiating user's name or other identifying information.

In some additional embodiments, both users may be anonymous. For example, an initiating user may start a conversation with a person randomly selected by a two-way anonymous communication (TWAC) system from the initiating user's contact list. In another embodiment, the target user may be chosen by a friend of the initiating user.

The selection of a target user may be restricted by individuals and/or groups (e.g., coworkers, clients, classmates, etc.). Although the selection may be initially limited to contacts with whom the initiating user has a contact request connection, the initiating user may then choose to further limit the pool of potential two-way anonymous communication partners by such terms as gender, location, and/or relationship status.

Once started, each of the initiating user and the target user may be able to communicate with the other to try to determine who the other person is. The TWAC system may provide clues to each user as discussed herein (e.g., purchasing clues, converting clues into identification information, etc.). Once one of the users determines who the other is, the system may proceed as a one-way anonymous communication.

Regardless of whomever starts the conversation, the OWAC system may have access to the identity of both the initiating user and the target user in the online social network and/or the OWAC system. The OWAC system may conceal the identity of a first communicating party (e.g., an initiating user or the target user) to a second communicating party (e.g., the other one of the initiating user and the target user). The OWAC system may reveal or confirm the identity of the second communicating party to the first communicating party, provide identity clues, and/or may disclose a relationship (e.g., “friend,” “coworker,” “employee”) between the first communicating party and the second communicating party to the second communicating party. Either the first communicating party or the second communicating party may initiate the private (or public, or semi-public) conversation with the other communicating party. In some embodiments, distribution of clues and or other identifying information may be restricted by the anonymous user.

### Information and Clues

Use of the OWAC system may imply that requirements and/or standard operating procedures of the OWAC system were satisfied before the initiating user could send the message request. For example, the OWAC system may require confirmation that the initiating user and the target user have a contact request connection. The contact request connection may exist when a contact request (e.g., a friend request, a business contact request, e.g., as a request to link in LinkedIn® etc.) has been accepted between the initiating user's contact group (including the initiating user) and the target user's contact group (including the target user). In other words, for a social network such as Facebook®, the initiating user and the target user may need to be friends-of-friends or friends in order to communicate.

The contact request connection between the initiating user and the target user may be an established relationship in the social network. For example, the initiating user and the target user may be categorized by the online social network as acquaintances, friends, in a relationship, friends-of-friends, co-workers, classmates, or other relationships. The relationship may be an automatic designation and/or a relationship agreed to by both the target user and the initiating user, and it may be stored in the profile data of the target user and/or the initiating user in the online social network and/or the OWAC system. The initiating user and the target user may both also be users of both the OWAC system as well as the online social network.

In addition to the OWAC's requirements and/or operating procedures, the OWAC system may also provide clues regarding the anonymous user's identity, for free and/or based on a fee (monetary or other type of fee). For example, the system may provide a few clues for free, and larger numbers of clues for set amounts such as $0.99 for 3 clues, $1.99 for 5 clues, $2.99 for 7 clues, etc. The system may provide clues based on a subscription fee, such as $0.99 per month or year. The system may limit the number of clues provided per day. The system may charge for responding to guesses as to the anonymous user's identity, such as for letters in a name, or for direct guesses about the anonymous user's full first and/or last name.

The order in which the OWAC system provides clues may be determined by an algorithm and/or may be randomized. For example, an OWAC algorithm may use gender as a first clue, current location (city) as a second clue, and a third clue may be chosen from work, education, and family. For the third clue, if the users have one factor in common, such as the same work place or type, that factor may be revealed first. If two or three factors are common, the clues may be provided based on a ranking. The ranking from highest to lowest for the factors may be: family, work, and education. Alternatively, common factors may be decided at random.

Many types of data may be used as clues regarding a user's (e.g., a target user's or an initiating user's) identity. Such clues may include one or more of: the type of relationship that exists between the initiating user and the target user in the online social network, gender, current location (city, state, country, street address, etc.), workplace (business name, address), prior workplace, educational background, friends, family members, co-workers, hair color, height, weight, duration of association, degrees of separation, ethnicity, vehicle type, and letters from a person's name, school, work, parts of individual and/or group photos, blurred or otherwise modified photos of the anonymous person, or other clues. Other clues may include accomplishments (awards, scholarships, grades, promotions, miles ran, elevation climbed), hobbies, personal history (number of people dated, persons who the user dated, persons with whom the user has been photographed), favorites (colors, foods, clothing), and aspirational goals (vacation destinations, careers, etc.). This information may be available via the user's profile in the online social network, via wall posts, from third parties who provide information to the OWAC system (e.g., friends of the target user and/or the initiating user, other users with a contact request connection with the target user and/or the initiating user), or may be provided by the user. For example, the user may fill out an OWAC profile with information to be provided to a specific target user or to be used generally with the OWAC system's algorithm for providing clues.

### Signup Notification

In an embodiment, when a user creates an account on the OWAC system, the OWAC system may post a notification on the user's online social network indicating that others may now contact them using the OWAC system. Additional persons who sign up for the OWAC system who are also associated with the user in the user's online social network may then contact the user while concealing their identity.

### EXPLANATION OF THE FIGURES

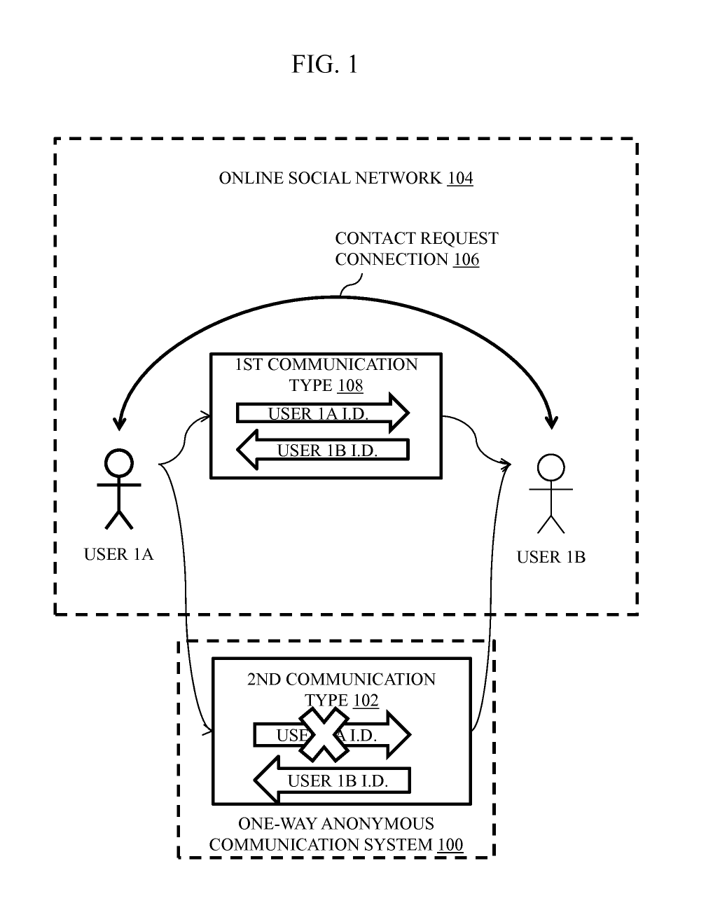

### FIGS. 1-3

FIG. 1 includes a one-way anonymous communication (OWAC) system 100, a 2nd communication type 102, an online social network 104, a contact request connection 106, a 1st communication type 108, user 1A, user 1B, user 1A I.D., and user 1B I.D. The online social network has a database associated therewith that contains user profiles for user 1A and user 1B, which include their user I.D.'s in association with personal information. Each of the operations performed by user 1A and/or user 1B in connection with the OWAC system 100 or the online social network 104 may involve the use of a device such as a smartphone, laptop, tablet, or desktop computer to interact with the OWAC system 100 or the online social network 104. Each of the 1st communication type and the 2nd communication type involve using a user interface to generate and relay communication to be transferred using the systems of the online social network 104 and/or the OWAC system 100.

As shown in FIG. 1, user 1A may initiate a one-way anonymous communication request with user 1B, with whom user 1A shares a contact request connection (also preferably in the online social network database). In other words, user 1A is associated with user 1B through a pre-existing relationship in the online social network 104, such as being friends, acquaintances, being friends-of-friends, or having another relationship (e.g., that each user already knows they have with each other).

The OWAC system 100 may be separate from the online social network 104, and operate using separate software and/or servers. The OWAC system may operate as an application (e.g., a smartphone app) with a separate login or the same login as the online social network. The OWAC system may request and obtain permission to acquire and distribute parts of the user's information from the online social network as clues when the user initiates an anonymous conversation with another user.

As shown, the 1st communication type 108 may be a standard communication and/or wall posting system that provides each participant with identifying information for the users, such as names and/or images of the users that correspond to their profile information stored in the online social network. When using the 1st communication type 108, user 1B receives user 1A's I.D. (e.g., name and/or image, or other identifying information), and user 1A receives user 1B's I.D. This communication is a standard or typical online social network communication where each user knows and recognizes the other.

When using the 2nd communication type 102 instead, user 1A is permitted to initiate a one-way anonymous conversation with user 1B. User 1A still receives user 1B's I.D., but user 1B is prevented (at least initially) from receiving user 1A's I.D. In a variation, the system may provide clues as to user 1A's I.D., and/or user 1A may impose restrictions on the clues that are provided.

Given that user 1B is aware that both user 1A and user 1B have a contact request connection 106, user 1B can communicate with user 1A in this one-way anonymous manner. In the variation where clues about user 1A can be obtained, user 1B may be more inclined to communicate with the anonymous person to see what they have to say. Either type of one-way anonymous communication may provide entertainment, and/or may allow a user to provide feedback that might otherwise be difficult to provide.

In some embodiments, the one-way anonymous communication from user 1A may be visible to other users, such as viewers of a wall posting. In such cases, other users of the online social network 104 and/or the OWACS system 100 may also be able to participate in attempting to figure out who the anonymous communicator is.

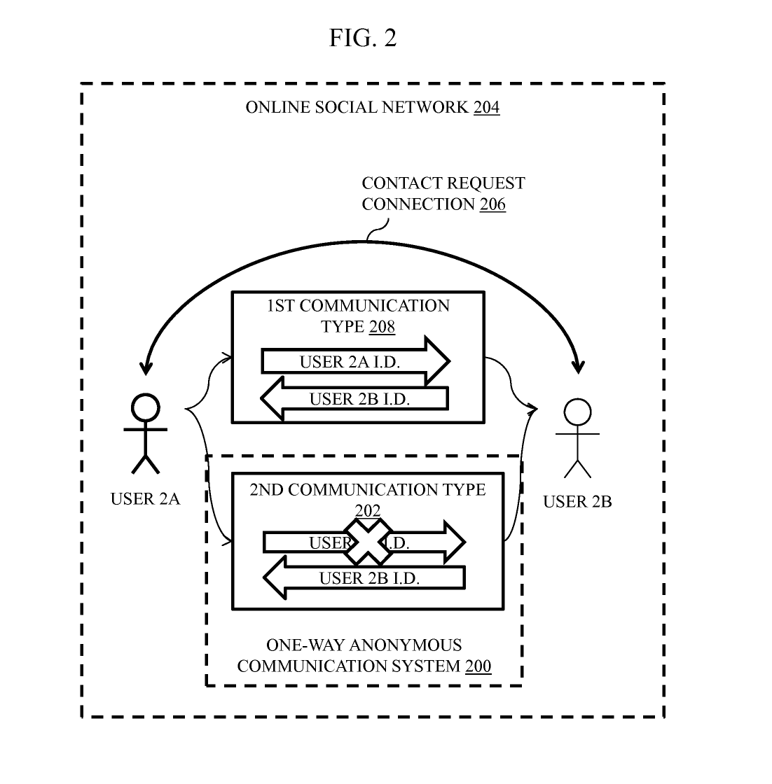

FIG. 2 includes a one-way anonymous communication (OWAC) system 200, a 2nd communication type 202, an online social network 204, a contact request connection 206, a 1st communication type 208, user 2A, user 2B, user 2A I.D., and user 2B I.D. Each of the operations performed by user 2A and/or user 2B in connection with the OWAC system 200 or the online social network 204 may involve the use of a device such as a smartphone, laptop, tablet, or desktop computer to interact with the OWAC system 200 or the online social network 204. Each of the 1st communication type and the 2nd communication type involve using a user interface to generate and relay communication to be transferred using the systems of the online social network 204 and/or the OWAC system 200.

The OWAC system of FIG. 2 may operate similarly to the OWAC system of FIG. 1, but may operate as part of the social network. As such, a separate login may not be needed, and fewer permissions or no permissions may need to be obtained separately from the permissions already obtained by the online social network. The servers and databases may therefore overlap and/or be identical for the online social network 204 and the OWACS system 200, and the profile information for the users may overlap and/or be the same.

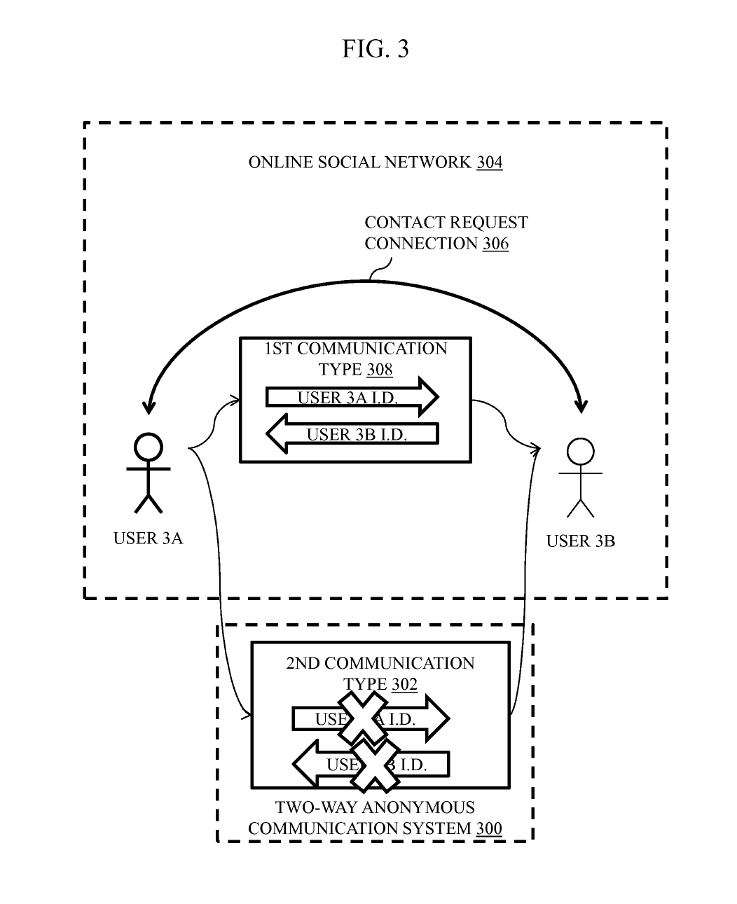

FIG. 3 includes a two-way anonymous communication (TWAC) system 300, a 2nd communication type 302, an online social network 304, a contact request connection 306, a 1st communication type 308, user 3A, user 3B, user 3A I.D., and user 3B I.D. Each of the operations performed by user 3A and/or user 3B in connection with the OWAC system 300 or the online social network 304 may involve the use of a device such as a smartphone, laptop, tablet, or desktop computer to interact with the OWAC system 300 or the online social network 304. Each of the 1st communication type and the 2nd communication type involve using a user interface to generate and relay communication to be transferred using the systems of the online social network 304 and/or the OWAC system 300.

The TWAC system of FIG. 3 may operate similarly to the OWAC systems of FIG. 1, but both user 3A and user 3B may communicate anonymously. The goal of such communication may be entertainment, and clues may be provided by the TWAC system with respect to each user's identity.

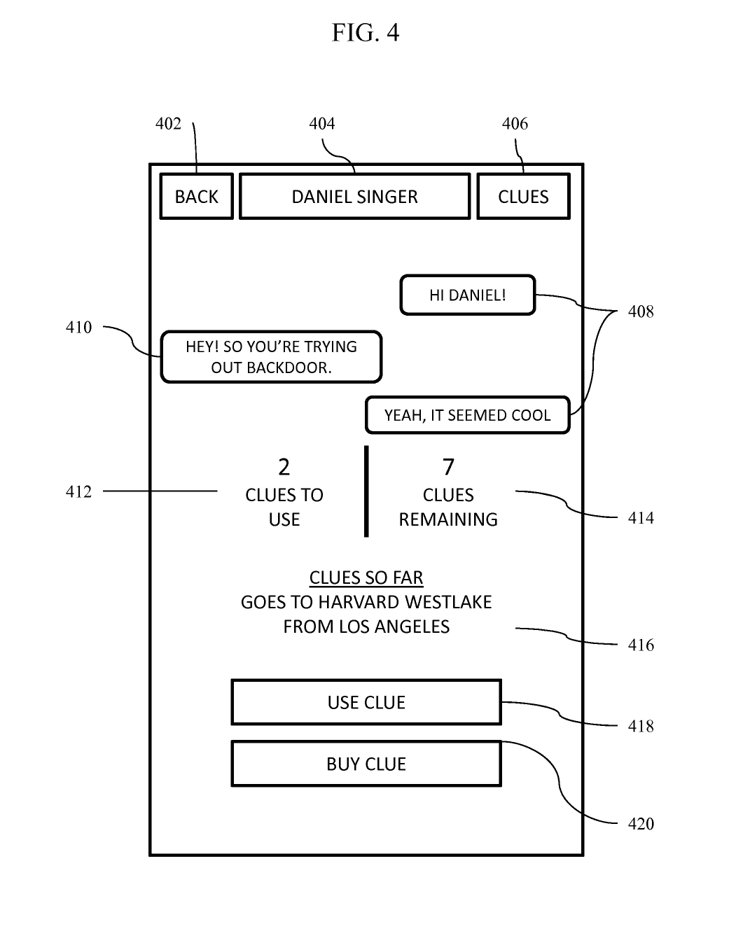

### FIG. 4

FIG. 4 includes back button 402, user identification 404, clues button 406, anonymous user messages 408, non-anonymous user messages 410, available clues 412, remaining clues 414, revealed clues 416, use-clue 418, and buy clue 420.

FIG. 4 is an illustration of a user interface for communicating with an anonymous user, viewing acquired clues, and obtaining additional clues. The user interface may permit the non-anonymous user to view user messages 408 and non-anonymous user messages 410 as well as revealed clues 416. The user may be provided with information such as available clues 412, which may be the number of clues that the non-anonymous user has been provided, whether through purchase, gift, part of a subscription, or other reasons. The non-anonymous user may also be able to view the number of remaining clues 414, which may provide the non-anonymous user with a basis for evaluating whether to purchase or obtain additional clues. A use-clue button 418 may permit the non-anonymous user to convert an available clue 412 into information about the anonymous user. Buy clue button 420 may permit the user to purchase additional clues to use in the current and/or other conversations.

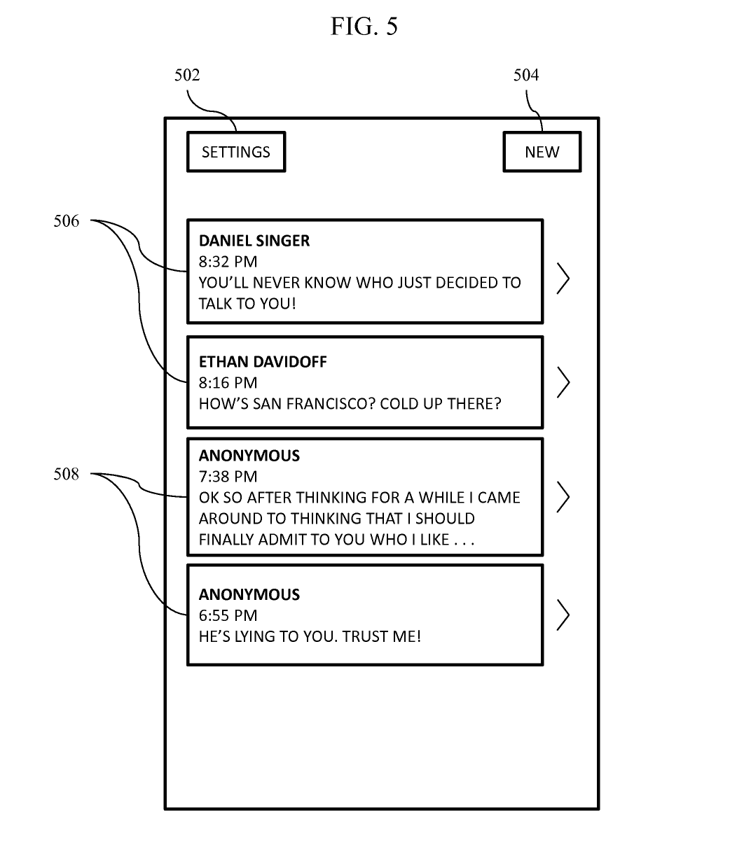

### FIGS. 5-7

FIG. 5 includes a settings button 502, new button 504, non-anonymous messages 506 and anonymous messages 508, and “next” or scroll buttons for the messages.

Non-anonymous messages 506 may be part of a one-way anonymous communication in which the current viewing user is anonymous to the other person. Alternatively, non-anonymous messages may simply be part of standard two-way non-anonymous conversations that are displayed along with one-way or two-way anonymous conversations.

Anonymous messages 508 may be part of one-way or two-way anonymous conversations.

New button 504 may permit the viewing user to initiate a conversation with another person.

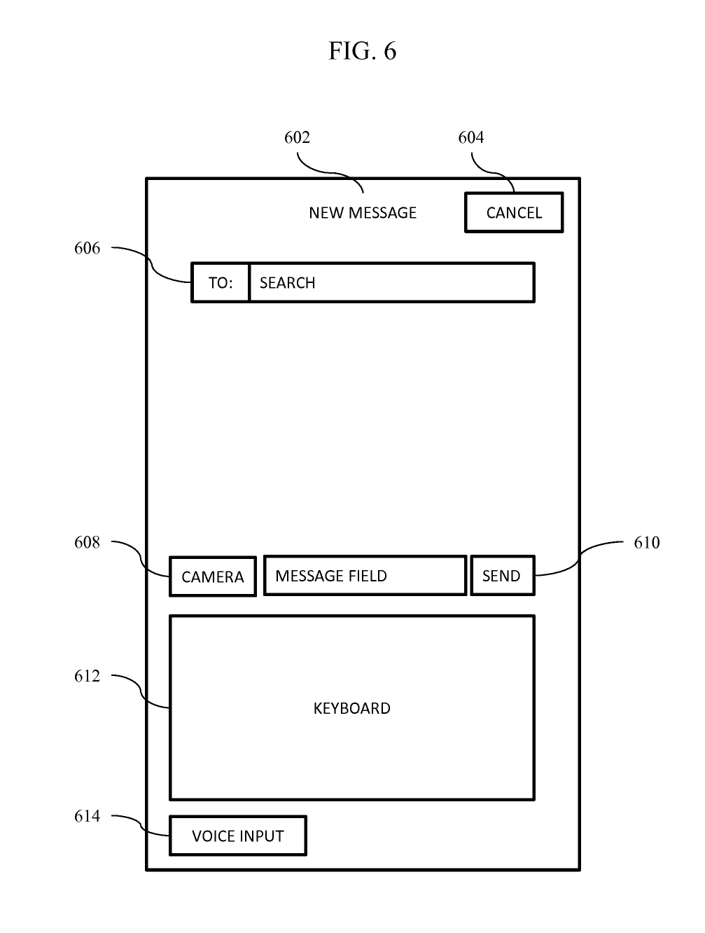

FIG. 6 includes new message header 602, cancel 604, to field 606, camera 608, send 610, keyboard 612, and voice input 614.

The interface of FIG. 6 may be used to initiate a new message, either anonymously or non-anonymously. The camera 608, keyboard 612, and voice input 614 options may permit the user to send text based, photo, video, or audio as part of a one-way anonymous message.

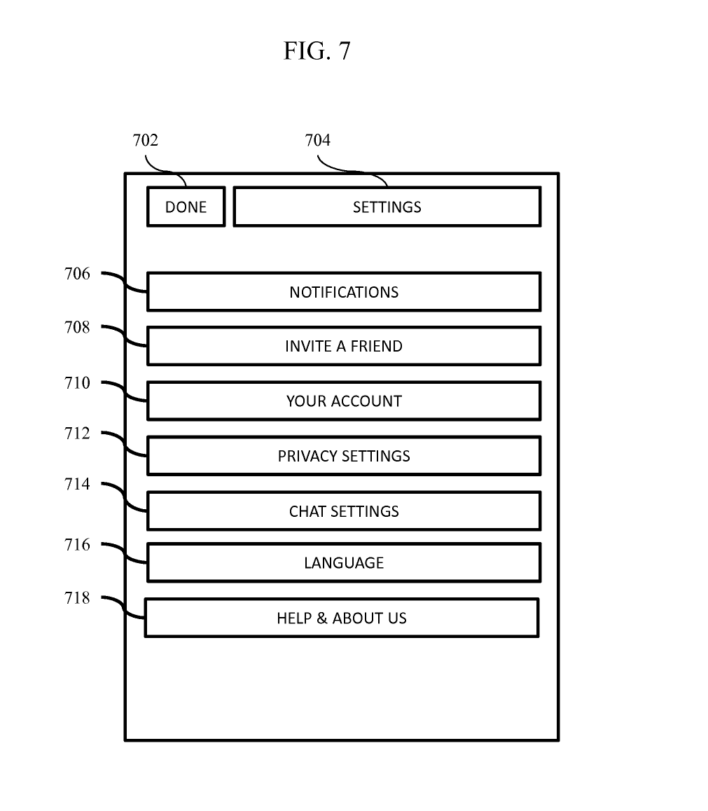

FIG. 7 includes done 702, settings header 704, notifications 706, invite a friend 708, your account 710, privacy settings 712, chat settings 714, language 716, help & about us 718.

Notifications 706 may permit a user to adjust what types of notifications they receive from an anonymous user and/or from a person with whom the user is having a one-way or two-way anonymous conversation.

Invite a friend 708 may permit the user to invite a friend to join the OWACS or TWACS system. The invite may in some embodiments be sent anonymously. In other embodiments, a friend may be invited to assist with identifying an anonymous communicator.

Privacy settings 712 may allow a user to determine what clues are or are not permitted for use by the OWACS or TWACS system to identify the user. The information may be identified by category and or by displaying a selection option for each piece of information considered for use by the system.

Chat settings 714 may adjust when the user is available for real-time chatting.

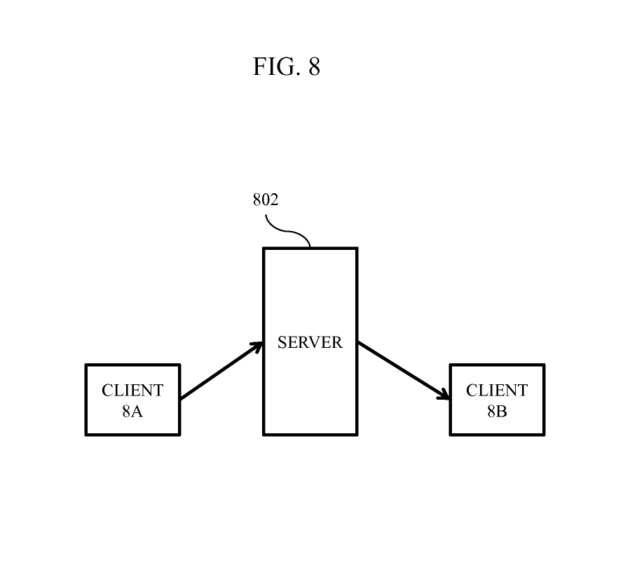

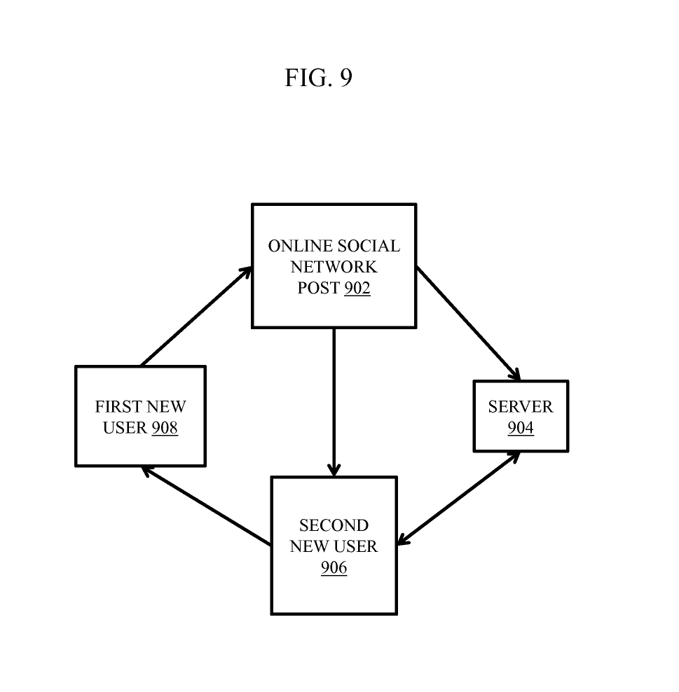

### FIGS. 8-9

As shown in FIG. 8, a user may start the one-way anonymous conversation by using a client 8A to send a message to be received by a second user. The message is received by a server 802 for the OWAC system, and may be stored by the server. The server 802 may confirm the relationship between the first user and the second user in the online social network, or the relationship may have previously been confirmed by the OWAC system. The server may modify the message to the second user by concealing the name (and I.D. and any other identifying information) of the first user. In some embodiments, the first user's name is replaced by an indicator of the relationship between the first user and the second user (e.g., friend, friend-of-friend, co-worker, acquaintance, etc.). A temporary I.D. (for purposes of the communication thread only) may be assigned in addition to the relationship indicator or in lieu thereof or the system may just use “anonymous.” The server may send the modified message to a second client 8B used by the second user.

As shown in FIG. 9, according to an embodiment, when a first new user 908 signs up for the OWAC system, the OWAC system posts a notification (online social network post 902) of the first new user's membership via the first new user's online social network. A second new user 906 who has a relationship (e.g., friendship, friend-of-friend, etc.) with first new user 908 may see the notification, and may also sign up for the OWAC system by clicking on a link embedded in the notification. After clicking on the link, second new user 906 may be directed to a website hosted by a server 904 of the OWAC system. The server 904 may confirm that the first new user 908 and the second new user 906 are known to each other because the second new user 906 signed up for the OWAC system via the first new user's 908 link. The OWAC system may also be given access by the first new user 908 and the second new user 906 to their respective lists of contacts and relationships with those contacts in the online social network. The OWAC system may be able to confirm the relationship between the first new user 908 and the second new user 906 by comparing the identities of the contacts in the first new user's 908 and the second new user's 906 lists of contacts with the identities of the first new user 908 and the second new user 906 that were provided during signup with the OWAC system.

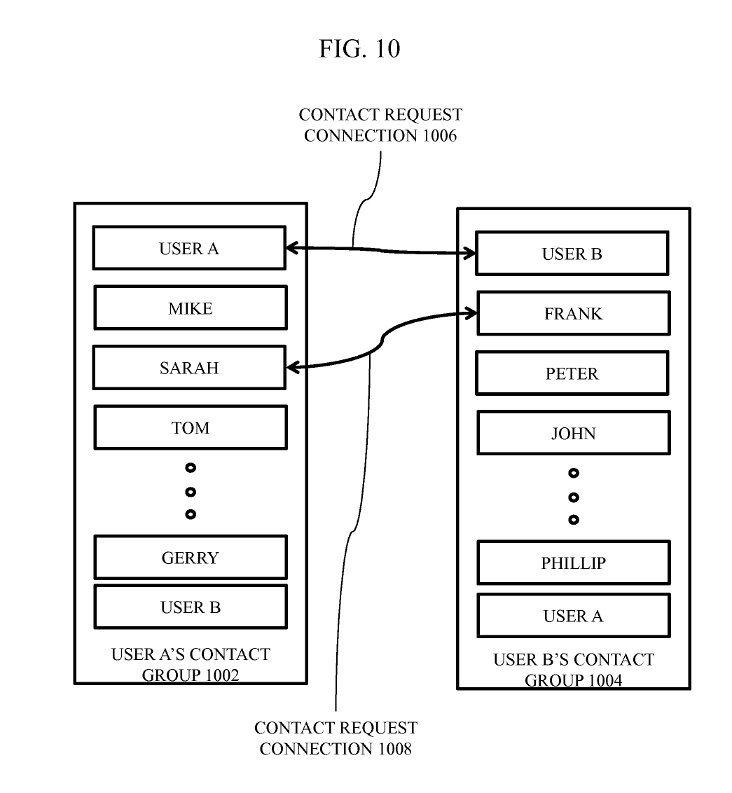

### FIG. 10

FIG. 10 includes a user A's contact group 1002, a user B's contact group 1004, a contact request connection 1006, and a contact request connection 1008.

User A's contact group 1002 includes user A and user A's contacts (e.g., friends in a Facebook® context, connections in LinkedIn, etc.), and the user B contact group includes user B and user B's contacts.

The contact request connection 1006 exists because either user A requested to be connected (e.g., friends) with user B, or user B requested that user A become connected with user B, and the requested party accepted. The contact request connection 1006 is a direct connection, where user B is already one of user A's contacts (e.g. friends).

The contact request connection 1008 exists because one Sarah and Frank exchanged and accepted a contact request, becoming directly connected. User A and user B are thus also connected through the contact request connection 1008.

By either the contact request connection 1006 or the contact request connection 1008, user A and user B are connected via a contact request connection.

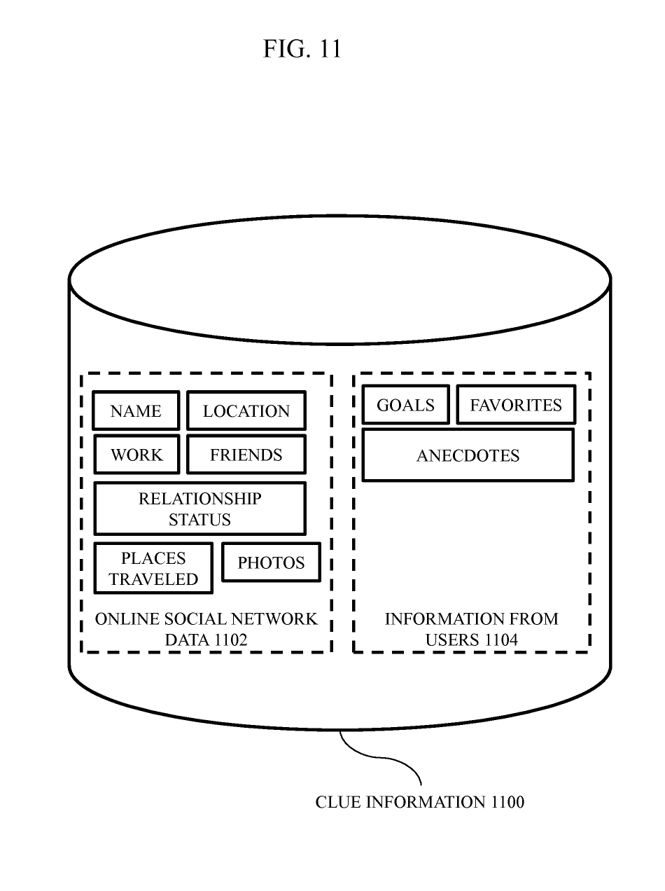

### FIG. 11

FIG. 11 includes clue information 1100, online social network data 1102, and information from users 1104.

Clue information 1104 may be the information that the one-way anonymous communication system or two-way anonymous communication system provides clues to the other party about an anonymous person's identity. The clue information 1100 may be derived from user profile or other information about a user included in online social network data 1102. Alternatively or in addition, the clue information 1100 may include goals, favorites, anecdotes, and/or other information provided by the user or a person familiar with the user, such as a friend, contact, or family member. The clue information may include a variety of information, as discussed above.

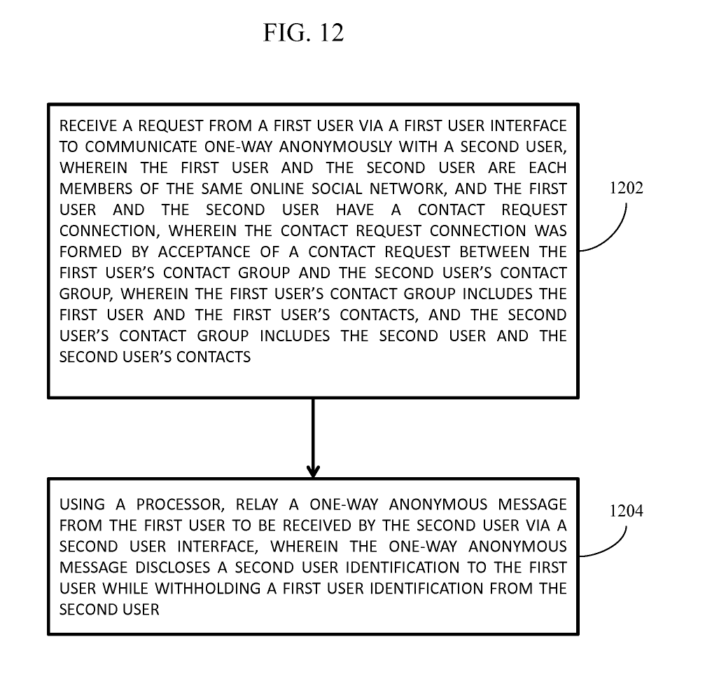

### FIG. 12

FIG. 12 illustrates a method of performing one-way anonymous communication, according to an embodiment. In operation 1202, the system receives a request from a first user via a first user interface to communicate one-way anonymously with a second user, wherein the first user and the second user are each members of the same online social network, and the first user and the second user have a contact request connection, wherein the contact request connection was formed by acceptance of a contact request between the first user's contact group and the second user's contact group, wherein the first user's contact group includes the first user and the first user's contacts, and the second user's contact group includes the second user and the second user's contacts. Here, the first user and the second user may be associated simply by being friends-of-friends, given that the first user and the second user may be connected through their respective contact groups' associations.

In operation 1204, using a processor, the system relays a one-way anonymous message from the first user to be received by the second user via a second user interface, wherein the one-way anonymous message discloses a second user identification to the first user while withholding a first user identification from the second user.

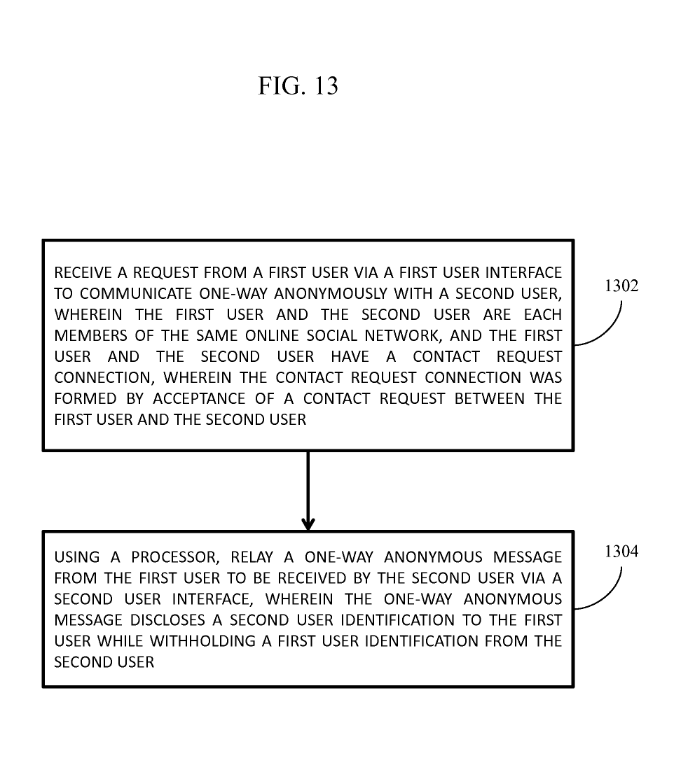

### FIG. 13

FIG. 13 illustrates a method of performing one-way anonymous communication, according to another embodiment. In operation 1302, the system receives a request from a first user via a first user interface to communicate one-way anonymously with a second user, wherein the first user and the second user are each members of the same online social network, and the first user and the second user have a contact request connection, wherein the contact request connection was formed by acceptance of a contact request between the first user and the second user. Here, the first user and the second user are directly connected given that a contact request (e.g., a friend request) was exchanged and accepted between the first and second user.

In operation 1304, using a processor, the system relays a one-way anonymous message from the first user to be received by the second user via a second user interface, wherein the one-way anonymous message discloses a second user identification to the first user while withholding a first user identification from the second user.

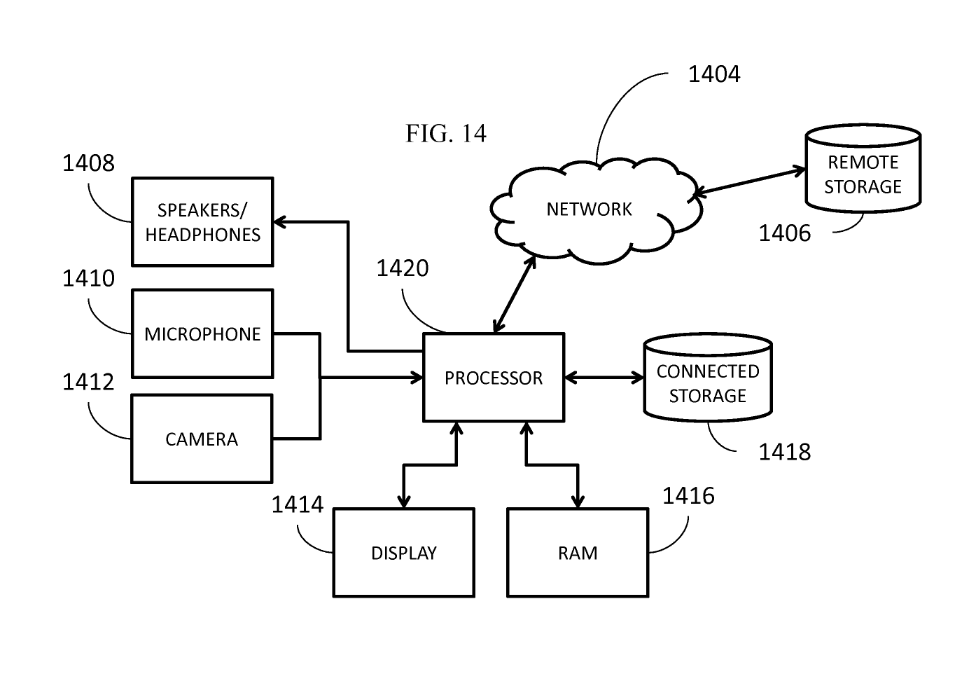

### FIG. 14

FIG. 14 is a block diagram of device components for performing the operations of the method of one-way and/or two-way anonymous communication, according to an embodiment. The system preferably includes a processor 1420, connected storage 1418, RAM 1416, a display 1414, a camera 1412, a microphone 1410, and speakers/headphones 1408. The processor 1416 is configured to execute instructions and carry out operations associated with the one way and/or two way communication system. For example, using instructions from RAM 1416 or the connected storage 1418, the processor 1420 may control the receiving and manipulating of data that is communicated between components of the one way and/or two way communication system. The processor 1420 may be implemented on a single-chip, multiple chips, or multiple electrical components. For example, the processor 1416 may be any one of various architectures, such as embedded processors, DSP, or ASIC. The connected storage 1418 may include one or more of additional RAM, ROM, a hard drive, or other tangible storage mediums.

The processor 1420 may execute computer code and produce and use data. An operating system, other computer code, and data may reside within the RAM 1416 and/or the connected storage 1418 that are operatively coupled to the processor 1420. The RAM 1416 and/or the connected storage may be used to store computer code and/or data used by the system.

The display 1414 is preferably a touch screen liquid crystal display (LCD) or other electronically controlled display. Non-touch receptive displays may be used in less preferred embodiments. The display 1414 may be configured to display a graphical user interface (GUI) that provides a user with a visual system for interacting with the operating system or an application. The GUI may represent programs, files, and operational options using graphical images such as windows, fields, dialog boxes, menus, icons, buttons, etc. The GUI may also display non-interactive text and graphics.

Some embodiments of the system may include one or more input devices such as mice, keyboards, additional touchscreens, and/or touchpads (not shown). The input devices may be operatively connected to the processor 1420 and configured to transfer data into the system. For example, the input devices may be used to make a selection through the GUI on the display 1414. The input devices may be used to issue commands for the system.

The system may be connected to a network 1404 such as the internet, a local area network, or a wide area network. The system may be connected through the network 1404 to remote storage 1406 such as a hard drive, network attached storage, and/or cloud storage. The system may also be connected via the network 1404, wireless, and/or wired connections to a personal computer or other mobile devices (not shown). Preferably, in one embodiment, the system and method of one-way and/or two-way anonymous communication may be embodied as a computer program and most preferably as a smart phone “App.”

The user may input commands to the system using a physical keyboard/keypad, a touch screen keyboard, verbal commands, motion sensors and/or orientation sensors. The media may be adaptively played back via output devices such as the speakers/headphones 228, and/or the display 202 (e.g., a mobile device screen or a television).

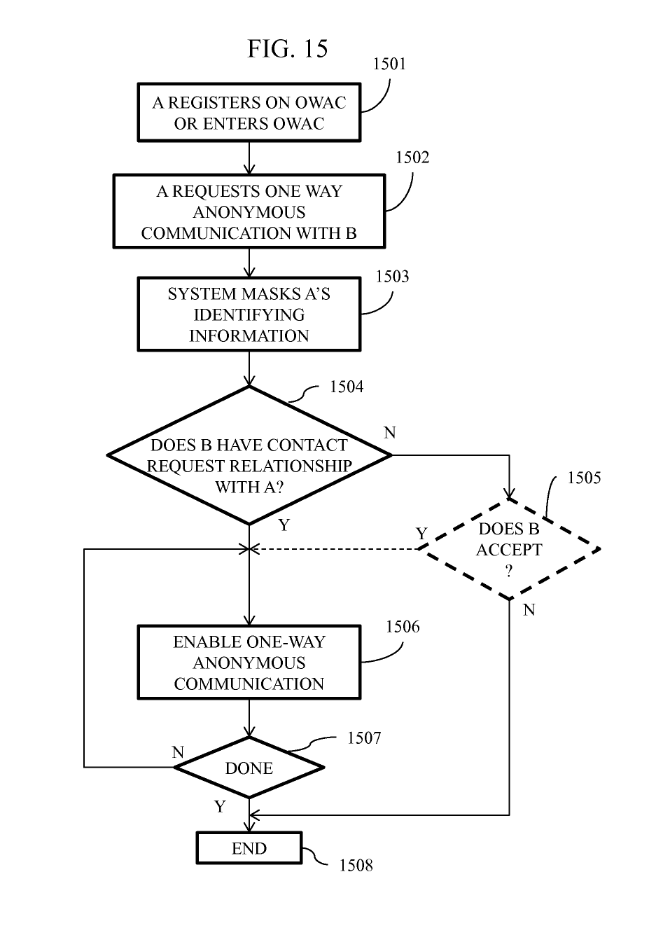

### FIG. 15

FIG. 15 is a flow chart of exemplary operations of a one-way anonymous communication system in accordance with an embodiment, using steps and apparatus previously disclosed herein. The steps herein may be performed in any logical order that preserves the masking of user A's identity in the communication through the one-way anonymous system with user B.

In step 1501, a user A registers with a one-way anonymous communication system by any method disclosed herein. In step 1502, user A requests a one-way anonymous communication with a user B. In step 1503, which may be performed now, or at any time up to and including in the communication, the system masks user A's identifying information from a communication with user B. User A and user B are previously known to each other, e.g., through an online social network, and/or through connections in the online social network(s) of user A's “friends” with user B or any of user B's friends, as otherwise disclosed herein.

In step 1504, the system confirms that user A and user B have a contact request relationship, in accordance with any other embodiment herein. If not, the system may optionally give user B a chance to accept a communication from user A even though there is no pre-existing contact request relationship.

If there is a contact request relation (step 1504) or if user B accepts (step 1505), then the system enables one-way anonymous communication at step 1506 (with user A's identity masked per step 1503). When the parties are done (step 1507), the system ends the communication (step 1508).

### Additional Embodiment Descriptions

In some embodiments, signup for the system may be performed through a social network such as Facebook®, Twitter®, or Google+®. The user may be provided with an option to sign in using one of several possible social networks. The user may be shown a profile screen, and be given the option to “pull down” on the screen interface to trigger a command. The user may be presented with an onscreen option to invite the user's friends to start an anonymous conversation with the user.

The user's invitation to his or her friends to start an anonymous conversation may appear in the user's social networking newsfeed (e.g., a Facebook® wall post). Additional potential users who are friends with the user or are otherwise associated with the user may see the invitation in their newsfeed from multiple other persons.

The user may be provided with a list of names and/or associated images for friends and other persons with whom the user can start an anonymous conversation. The other persons may also be registered members of the system, and the system may acquire the images and confirm the relationship between the user and the other persons by accessing each person's social networking information.

Once each additional user becomes a registered user of the system, a notification may be generated that allows the contacts of the new users to sign up with the system, which may assist with advertising and membership growth.

### Exemplary User Interfaces

In some embodiments, a conversation displayed to a first user via a user interface may include the name of the other conversing person (e.g., a second user of the system who is conversing with the first user) displayed at the top middle of the header. If the first user is the anonymous user in a one-way anonymous conversation, the real name of the target user may be displayed. If the viewing user is the non-anonymous user in a one-way anonymous conversation, the system may display “???” instead of a name.

The system may enable the first user to select a recipient from a list of contacts. The system may populate the list with the first user's Facebook® friends and/or other contacts such as acquaintances, friends-of-friends, coworkers, classmates, etc. The first user's phone contacts and Facebook® contacts lists may be merged and arranged in alphabetical order.

When the first user is creating a new message, the system may provide the first user with a list of suggested auto-complete names. The list of suggested auto-complete names may also include the first user's Facebook® friends and/or other contacts.

### Creating New Threads

In some embodiments, potential recipients of one-way anonymous messages may include: 1) existing users of the OWAC system; 2) telephone contacts; 3) social network contacts. For existing users of the OWAC system, when the initiating user generates a message, it is sent to the server, and the server sends a modified message to the recipient's client (e.g., a mobile device communicating with the server, a laptop, a terminal, a smartphone, tablet computer, etc.). For telephone contacts, the system may use a TWILIO API. The initiating user generates a message that is sent to the server, which sends a modified message via the TWILIO API with the sender's phone number anonymized. For social network (e.g., Facebook) friends who are not existing users of the OWAC system and who do not have a phone number in the initiating user's contact book, the initiating user may be prompted to enter the target recipient's phone number in order to send the message. The system may then use the TWILIO API as described above for phone contacts to send the message anonymously or one-way anonymously to the recipient.

### Handling User Duplicates

The system may avoid or limit the number of duplicate entries by using phone numbers for contacts. For example, if a social network friend has a phone number that appears in the user's phone contact list, the system may avoid creating a new contact based on the duplicate social network contact. Other new contacts (e.g., other users of the OWAC system) may similarly be eliminated for duplicate phone numbers.

Although the invention has been described using specific terms, devices, and/or methods, such description is for illustrative purposes of the preferred embodiment(s) only. Changes may be made to the preferred embodiment(s) by those of ordinary skill in the art without departing from the scope of the present invention, which is set forth in the following claims. In addition, it should be understood that aspects of the preferred embodiment(s) generally may be interchanged in whole or in part.

What is claimed is:

1. A method of a one-way anonymous communication system, the method comprising the steps of:
receiving, by a one-way anonymous communication system, a request from a first user via a first user interface to communicate one-way anonymously with a second user,
confirming, by the one-way anonymous communication system, that the first user and the second user are each members of an online social network, and confirming that the first user and the second user have a contact request connection in the online social network, wherein the contact request connection was formed by acceptance of a contact request between the first user's contact group and the second user's contact group, and including a step of confirming, by the one-way anonymous message system, that the first user's contact group includes the first user and the first user's contacts, and the second user's contact group includes the second user and the second user's contacts; and
the one-way anonymous communication system relaying a one-way anonymous message from the first user to be received by the second user via a second user interface, wherein the one-way anonymous communication system provides in connection with the message identifying data of the second user to the first user while withholding identifying data of the first user from the second user,
whereby the first user may communicate with the second user who are each identifiable to each other in the online social network by using the one-way anonymous communication system.

2. The method of claim 1, wherein the one-way anonymous communication system operates externally to the online social network.

3. The method of claim 1, wherein the one-way anonymous communication system is part of the online social network.

4. The method of claim 2, wherein in the step of confirming, the one-way anonymous communication system confirms that the first user and the second user have a contact request connection because a contact request between the first user and the second user was accepted in the online social network, and wherein both the first user's identifying data and the second user's identifying data were provided to each other in the online social network prior to the step of requesting one-way anonymous communication.

5. The method of claim 1, wherein in the step of confirming, the one-way anonymous communication system confirms that a relationship exists between the first user and the second user in the online social network by accessing a list of contacts for at least one of the first user and the second user in the online social network, and obtaining a match with user profile information in the online social network with user profile information for at least one of the first user and the second user in the one-way anonymous communication system.

6. The method of claim 1, further comprising a step of providing, by the one-way anonymous communication system, a clue regarding a first user identity to be displayed to the second user on the second user interface.

7. The method of claim 6, further comprising a step of providing, by the one-way anonymous communication system, an option to be viewed by the second user on the second user interface to buy an additional clue.

8. The method of claim 6, further comprising a step of providing, by the one-way anonymous communication system, an option to be viewed by the second user on the second user interface to use a previously purchased clue.

9. The method of claim 6, wherein in the step of providing the clue, the clue was automatically obtained by the one-way anonymous communication system, and the clue comprises information about the first user obtained from the online social network.

10. The method of claim 6, wherein the clue is provided according to an algorithm.

11. The method of claim 10, wherein in the step of providing the clue by the one-way anonymous communication system, a first clue presented comprises the first user's gender.

12. The method of claim 10, wherein in the step of providing the clue by the one-way anonymous communication system according to the algorithm, the one-way anonymous communication system provides a clue comprising a profile data point shared in common between the first user and the second user earlier than other data points.

13. A tangible computer readable storage medium comprising instructions that, when executed by a processor, cause the processor to perform operations comprising:
receiving, by the processor, a request from a first user via a first user interface to communicate one-way anonymously with a second user,
determining, by the processor, that the first user and the second user are each members of the same online social network, and that the first user and the second user have a contact request connection, wherein the contact request connection was formed by acceptance of a contact request between a contact group of the first user and a contact group of the second user, and wherein the first user's contact group includes the first user and the first user's contacts, and the second user's contact group includes the second user and the second user's contacts; and
relaying, by the processor, a one-way anonymous message from the first user to be received by the second user on a second user interface, wherein the one-way anonymous message discloses identifying data of the second user to the first user while withholding identifying data of the first user from the second user.

14. The tangible computer readable storage medium of claim 13, wherein the one-way anonymous communication system operates externally to the online social network.

15. The tangible computer readable storage medium of claim 13, wherein the one-way anonymous communication system is part of the online social network.

16. The tangible computer readable storage medium of claim 14, wherein the first user and the second user have a contact request connection because a contact request between the first user and the second user was accepted, and wherein both an identity of the first user and an identity of the second user were provided to each other in the online social network.

17. The tangible computer readable storage medium of claim 13, further comprising instructions that, when executed by the processor, cause the processor to perform operations including:
confirming that a relationship exists between the first user and the second user in the online social network by accessing the list of contacts for at least one of the first and second user in the online social network; and
obtaining a match with the user profile information of at least one of the first user and the second user in the one-way anonymous communication system.

18. The tangible computer readable storage medium of claim 13, further comprising instructions that, when executed by the processor, cause the processor to perform operations including providing a clue regarding a first user identity to be displayed via the second user interface.

19. The method of claim 18, further comprising providing an option to be viewed by the second user via the second user interface to buy an additional clue.

20. A one-way anonymous communication system, comprising:
a first user interface configured to receive a request from a first user to communicate one-way anonymously with a second user,
wherein the first user and the second user are each members of the same online social network, and the first user and the second user have a contact request connection,
wherein the contact request connection was formed by acceptance of a contact request between the first user's contact group and the second user's contact group,
wherein the first user's contact group includes the first user and the first user's contacts, and the second user's contact group includes the second user and the second user's contacts; and
a processor configured to relay a one-way anonymous message from the first user to be received by the second user via a second user interface, wherein the one-way anonymous message discloses a second user identification to the first user while withholding a first user identification from the second user.
